(19) United States
(12) Patent Application Publication
(10) Pub. No.: US 2015/0102910 A1
(43) Pub. Date: Apr. 16, 2015

(54) RFID TAG SYSTEM AND OPERATING METHOD THEREOF

(71) Applicant: ELECTRONICS AND TELECOMMUNICATIONS RESEARCH INSTITUTE, Daejeon (KR)

(72) Inventors: Kyu Won HAN, Daejeon (KR); Sang Hyun MO, Daejeon (KR); Dong-Beom SHIN, Daejeon (KR); Kwang-Soo CHO, Daejeon (KR); Chan-Won PARK, Daejeon (KR); Cheol Sig PYO, Daejeon (KR)

(73) Assignee: ELECTRONICS AND TELECOMMUNICATIONS RESEARCH INSTITUTE, Daejeon (KR)

(21) Appl. No.: 14/509,657

(22) Filed: Oct. 8, 2014

(30) Foreign Application Priority Data
Oct. 14, 2013 (KR) 10-2013-0122200
Oct. 2, 2014 (KR) 10-2014-0133486

(51) Int. Cl. G06K 7/10

(52) U.S. Cl. CPC G06K 7/10009
USPC 340/10.1

(57) ABSTRACT

Disclosed herein are a radio frequency identification (RFID) system and an operating method thereof. The RFID system includes an RFID tag and an RFID reader transmitting an initialization command to the RFID tag. The initialization command includes a field selecting a single tag accessing mode and a multi-tag processing mode. The RFID reader performs a single tag authentication procedure, which is a procedure of one-to-one accessing one RFID tag, in the case in which the field is set to the single tag accessing mode.

### CROSS-REFERENCE TO RELATED APPLICATION

This application claims priority to and the benefit of Korean Patent Application No. 10-2013-0122200, and No. 10-2014-0133486 filed in the Korean Intellectual Property Office on Oct. 14, 2013, and Oct. 2, 2014, repectively, the entire contents of which are incorporated herein by reference.

### BACKGROUND OF THE INVENTION

(a) Field of the Invention

The present invention relates to a radio frequency identification (RFID) tag system and an operating method thereof.

(b) Description of the Related Art

In accordance with the development of a technology, a radio frequency identification (RFID) system has been used in various application fields, and an amount of data that may be stored by an RFID tag has gradually increased. Therefore, the necessity to a more rapid data processing speed in the RFID system has increased. However, currently, in a specification defined in ISO/IEC 18000-63, a user has a limitation in rapidly accessing the data of the RFID tag.

An existing RFID system has performed a procedure of processing a multi-tag and a procedure of accessing a single tag stepwise in order to access data of the tag. That is, after the procedure of processing a multi-tag was performed, the procedure of accessing a single tag was performed, such that a processing speed was unnecessarily late.

In addition, the existing RFID system initially sets repeatedly an unnecessary parameter in order to access the data of the tag, such that a time required for accessing the data of the tag was further delayed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a radio frequency identification (RFID) system and an operating method thereof having advantages of rapidly accessing data of a tag.

An exemplary embodiment of the present invention provides an operating method of an RFID reader accessing data of an RFID tag. The operating method of an RFID reader includes: configuring an initialization command including a first field selecting a single tag accessing mode and a multi-tag processing mode; transmitting the initialization command to the RFID tag; and performing a single tag authentication procedure, which is a procedure of one-to-one accessing one RFID tag, in the case in which the first field is set to the single tag accessing mode.

The operating method of an RFID reader may further include: performing a multi-tag processing procedure, which is a procedure of selecting one of a plurality of RFID tags, in the case in which the first field is set to the multi-tag processing mode.

The operating method of an RFID reader may further include: after the performing of the single tag authentication procedure, determining whether a response has been received from a plurality of RFID tags; and performing a multi-tag processing procedure, which is a procedure of selecting one of the plurality of RFID tags, in the case in which the response is received from the plurality of RFID tags.

The operating method of an RFID reader may further include: after the performing of the multi-tag processing procedure, performing the single tag authentication procedure.

The initialization command may further include a field indicating modulation and demodulation formats and a field indicating a data transmission speed.

The operating method of an RFID reader may further include: after the performing of the single tag authentication procedure, accessing the data of the RFID tag.

Another exemplary embodiment of the present invention provides an operating method of an RFID tag transmitting data in the case in which the RFID tag is positioned in a recognition region of an RFID reader. The operating method of an RFID tag includes: receiving an initialization command including a first field indicating a high speed operation mode and a general operation mode from the RFID reader; and performing a single tag authentication procedure, which is a procedure of one-to-one accessing the RFID reader, in the case in which the first field is set to the high speed operation mode.

The operating method of an RFID tag may further include: performing a multi-tag processing procedure with the RFID reader, in the case in which the first field is set to the general operation mode.

The multi-tag processing procedure may be a procedure in which the RFID reader selects one of the RFID tag and RFID tags other than the RFID tag.

The operating method of an RFID tag may further include: after the performing of the single tag authentication procedure, performing a multi-tag processing procedure with the RFID reader in the case in which the RFID reader receives a response from the RFID tag and RFID tags other than the RFID tag.

The initialization command may further include a field indicating modulation and demodulation formats and a field indicating a data transmission speed.

Yet another exemplary embodiment of the present invention provides an RFID system including: an RFID tag; and an RFID reader accessing data of the RFID tag and transmitting an initialization command to the RFID tag, wherein the initialization command includes a first field selecting a single tag accessing mode and a multi-tag processing mode, and the RFID reader performs a single tag authentication procedure, which is a procedure of one-to-one accessing one RFID tag, in the case in which the first field is set to the single tag accessing mode.

The RFID reader may perform a multi-tag processing procedure, which is a procedure of selecting one of a plurality of RFID tags, in the case in which the first field is set to the multi-tag processing mode.

After the single tag authentication procedure is performed, the RFID reader may perform a multi-tag processing procedure, which is a procedure of selecting one of a plurality of RFID tags in the case in which a response is received from the plurality of RFID tags.

The RFID reader may include a central processing unit configuring the initialization command, and the central processing unit may include a tag mode selecting unit processing a command selecting one of the single tag accessing mode and the multi-tag processing mode.

According to an exemplary embodiment of the present invention, the RFID tag directly enters the single tag authentication procedure through the tag operation mode of the initialization command, thereby making it possible to rapidly access the data of the tag.

### BRIEF DESCRIPTION OF THE DRAWINGS

FIG. 1 is a diagram showing a radio frequency identification (RFID) system according to an exemplary embodiment of the present invention.

FIG. 2 is a diagram schematically showing an initialization command 300 according to an exemplary embodiment of the present invention.

FIG. 3 is a diagram showing a state transition of an RFID tag according to an exemplary embodiment of the present invention.

FIG. 4 is a diagram showing the case in which a single tag authentication procedure is performed through the initialization command according to an exemplary embodiment of the present invention.

FIG. 5 is a diagram showing the case in which a multi-tag processing procedure is performed through the initialization command according to another exemplary embodiment of the present invention.

FIG. 6 is a diagram showing the case in which a single tag authentication procedure and a multi-tag processing procedure are performed through the initialization command according to still another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

A radio frequency identification (RFID) system according to an exemplary embodiment of the present invention supports a high speed operation mode. In order to support the high speed operation mode, the RFID system according to an exemplary embodiment of the present invention may select a single tag accessing mode and a multi-tag processing mode. In other words, the RFID system according to an exemplary embodiment of the present invention is classified into a high speed operation mode transited to the single tag accessing mode and a general operation mode transited to the multi-tag processing mode.

An entire procedure of the RFID system performing the high speed operation mode is as follows. In the case in which the RFID system is in a ready state, a tag is also transited to a ready state and waits for a command. A reader configures a command based on a communication speed or modulation and demodulation formats set by a user, a tag that is intended to be activated, or the like, and transmits an initialization command to the tag. Here, the initialization command includes the single tag accessing mode. The tag receiving the initialization command including the single tag accessing mode may enter a single tag authentication procedure and be then transited to a tag data access state. Further, in the RFID system entering the single tag authentication procedure, in the case in which the reader senses collision between tags, the tag is transited to the multi-tag processing procedure.

An entire procedure of the RFID system performing the general operation mode is as follows. In the case in which the RFID system is in a ready state, a tag is also transited to a ready state and waits for a command. A reader configures a command based on a communication speed or modulation and demodulation formats set by a user, a tag that is intended to be activated, or the like, and transmits an initialization command to the tag. Here, the initialization command includes the multi-tag processing mode. The tag receiving the initialization command including the multi-tag processing mode enters a multi-tag processing procedure, and the multi-tag processing procedure is performed so that one-to-one communication between the reader and the tag is possible. After the multi-tag processing procedure, the tag may be transited to the tag data access state through the single tag authentication procedure.

Meanwhile, in the following description, both of a tag and an RFID tag may be used together, and both of a reader and an RFID reader may be used together.

Hereinafter, an RFID system and an operating method thereof according to an exemplary embodiment of the present invention will be described in detail with reference to the accompanying drawings.

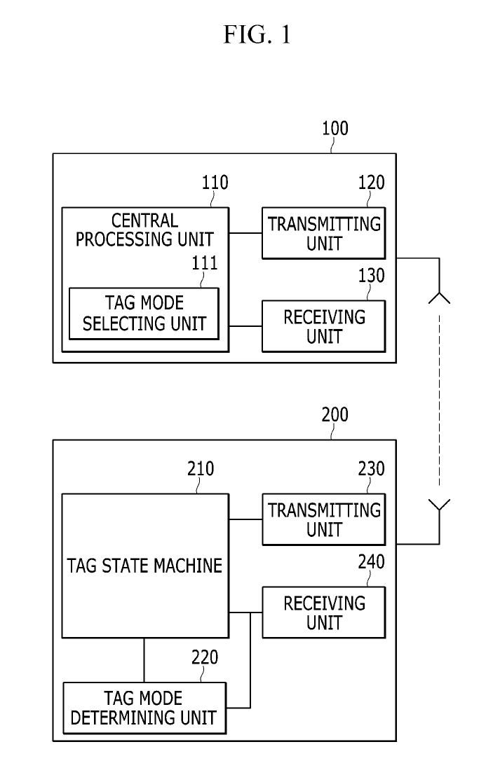

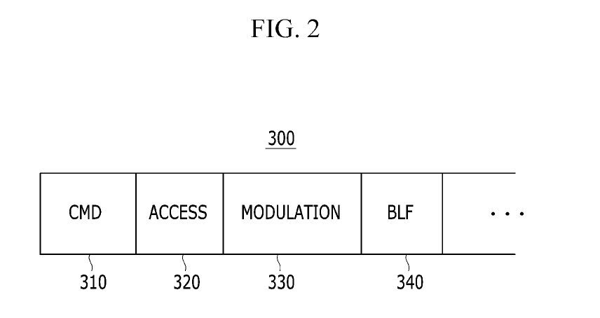

FIG. 1 is a diagram showing a radio frequency identification (RFID) system according to an exemplary embodiment of the present invention; and FIG. 2 is a diagram schematically showing an initialization command 300 according to an exemplary embodiment of the present invention.

As shown in FIG. 1, the RFID system according to an exemplary embodiment of the present invention includes an RFID reader 100 and an RFID tag 200.

When the RFID tag 200 is put in a recognition region of the RFID reader 100, the RFID reader 100 transmits a command to the RFID tag 200, and the RFID tag 200 performs the command of the RFID reader 100 and responds to the RFID reader 100. Meanwhile, the RFID reader 100 according to an exemplary embodiment of the present invention may select a single tag accessing mode and a multi-tag processing mode at the time of an initialization command. In addition, the RFID tag 200 enters a single tag authentication procedure to thereby be transited to a tag data access state, in the case in which a single tag accessing mode is included in the initialization command 300.

The RFID reader 100 includes a central processing unit 110, a transmitting unit 120, and a receiving unit 130. The central processing unit 110 generally controls an RFID processing operation. The central processing unit 110 according to an exemplary embodiment of the present invention may include a tag mode selecting unit 111. The tag mode selecting unit 111 processes a command selecting a tag operation mode, and the central processing unit 110 configures an initialization command 300 based on the tag operation mode selected by the tag mode selecting unit 111 and a command desired by a user. That is, the tag mode selecting unit 111 selects and processes a mode desired by the user in the single tag accessing mode and the multi-tag processing mode, and the central processing unit 110 configures an entire initialization command 300 including the selected tag operation mode.

As shown in FIG. 2, the initialization command 300 may include a CMD field 310 indicating a kind of command, an ACCESS field 320 indicating a tag operation mode, a MODULATION field 330 indicating modulation and demodulation formats, and a BLF field 340 indicating an operation speed. This initialization command 300 may be set by the user.

A use purpose of the command is indicated in the CMD field 310. That is, the CMD field 310 includes information indicating the initialization command.

The ACCESS field 320 includes information indicating the tag operation mode. For example, in the case in which the ACCESS field 320 is ‘0’, it may indicate the single tag accessing mode, and in the case in which the ACCESS field 320 is ‘1’, it may indicate the multi-tag processing mode.

The MODULATION filed 330 includes information indicating the modulation and demodulation formats. That is, in the MODULATION field 330, the modulation and demodulation formats from the RFID tag 200 to the RFID reader 100 are set.

In the BLF field 340, a data transmission speed from the RFID tag 200 to the RFID reader 100 is set.

Meanwhile, the initialization command 300 according to an exemplary embodiment of the present invention may further include target tag information that is intended to be activated, or the like, in addition to the fields shown in FIG. 2.

Again referring to FIG. 1, the transmitting unit 120 and the receiving unit 130 process transmission to and reception from the RFID tag 200, respectively.

The RFID tag 200 includes a tag state machine 210, a tag mode determining unit 220, a transmitting unit 230, and a receiving unit 240.

The tag state machine 210 processes a command of the RFID reader 100. The tag state machine 210 transits a tag state depending on the command of the RFID reader 100 and performs an operation in each tag state. For example, the tag state machine 210 performs an operation depending on the single tag accessing mode in the case in which the single tag accessing mode is set in the initialization command of the RFID reader 100. In addition, the tag state machine 210 performs an operation depending on the multi-tag processing mode in the case in which the multi-tag processing mode is set in the initialization command of the RFID reader 100.

The tag mode determining unit 220 determines a tag operation mode depending on the initialization command configured by the RFID reader 100 and transfers the determined tag operation mode to the tag state machine 210. That is, the tag mode determining unit 220 determines the tag operation mode by recognizing information included in the ACCESS field 320 of the initialization command transmitted from the RFID reader 100 and transfers the tag operation mode to the tag state machine 210.

The transmitting unit 230 and the receiving unit 240 process transmission to and reception from the RFID reader 100, respectively.

Meanwhile, although only the case in which the number of RFID tags 200 is one has been shown in FIG. 1, the number of RFID tags 200 may be plural.

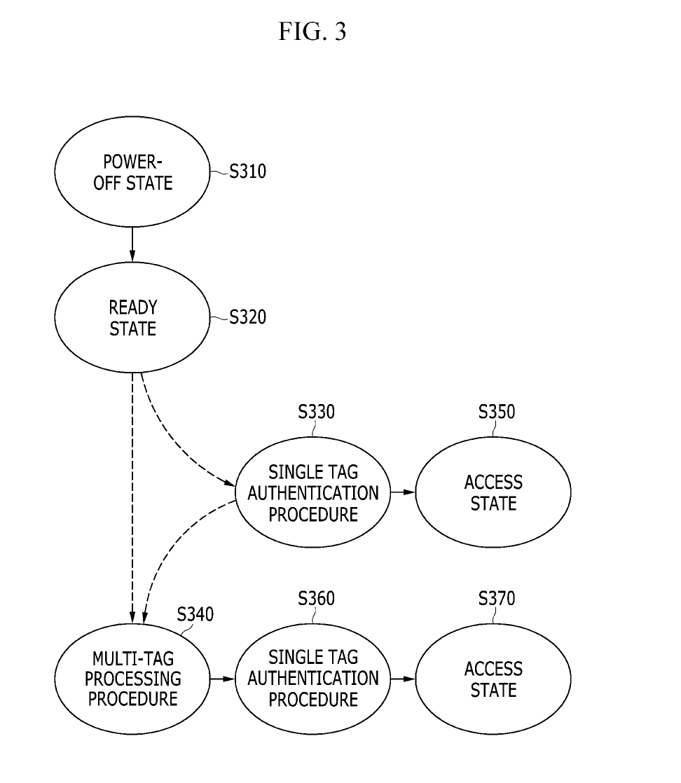

FIG. 3 is a diagram showing a state transition of an RFID tag according to an exemplary embodiment of the present invention. A state transition of an RFID tag to be described below may be performed in the tag state machine 210 described above.

As shown in FIG. 3, the RFID tag 200 may execute a POWER-OFF STATE (S310). The POWER-OFF STATE indicates a state before the RFID tag 200 enters an RF recognition region (RF field) provided by the RFID reader 100.

In the case in which the RFID tag 200 enters the RF field, the RFID tag 200 is transited to a READY STATE (S320). Here, the READY STATE indicates the case in which the RFID tag 200 is in a holding state rather than a single tag authentication procedure or a multi-tag authentication procedure. In the case in which the RFID tag 200 that is in the READY STATE receives the initialization command from the RFID reader 100, it enters the next state.

The RFID tag 200 receiving the initialization command determines the tag operation mode through the ACCESS field 320 of the initialization command. The RFID tag 200 determines that the tag operation mode is the single tag accessing mode and enters the single tag authentication procedure (S330), in the case in which the ACCESS field 320 of the initialization command is set to ‘0’. In addition, the RFID tag 200 performs an operation depending on configurations (for example, modulation and demodulation formats, an operation speed, and the like) set in the initialization command simultaneously with entering the single tag authentication procedure.

Meanwhile, in the case in which the RFID reader 100 senses collision for a response of the RFID tag 200 in the single tag authentication procedure, the RFID reader 100 transfers a command allowing the RFID tag 200 to enter a multi-tag procedure to the RFID tag 200. In this case, the RFID tag 200 is transited from the single tag authentication procedure to the multi-tag processing procedure (S330 and S340).

In the case in which the RFID reader 100 does not sense the collision for the response of the RFID tag 200 in the single tag authentication procedure, the RFID tag 200 is transited to an ACCESS STATE (S350). The ACCESS STATE indicates a state in which the RFID reader 100 may access the RFID tag 200 after the single tag authentication procedure, and a data exchange, a state exchange, or a function depending on a user's purpose may be performed.

The RFID tag 200 determines that the tag operation mode is the multi-tag processing mode and enters the multi-tag processing procedure (S320 and S340), in the case in which the ACCESS field 320 of the initialization command is set to ‘1’. In addition, the RFID tag 200 performs an operation depending on configurations (for example, modulation and demodulation formats, an operation speed, and the like) set in the initialization command simultaneously with entering the multi-tag processing procedure.

In addition, one-to-one communication between the RFID reader 100 and the RFID tag 200 becomes possible through the multi-tag processing procedure, and the single tag authentication procedure between the RFID reader 100 and the RFID tag 200 is performed (S360). In the case in which the single tag authentication procedure is normally performed, the RFID tag 200 is transited to an ACCESS STATE (S360). The ACCESS STATE indicates a state in which the RFID reader 100 may access the RFID tag 200 after the single tag authentication procedure, and a data exchange, a state exchange, or a function depending on a user's purpose may be performed. That is, in the ACCESS STATE, the RFID tag 200 may execute a tag data access command transmitted by the RFID reader 100.

Here, the single tag authentication procedure indicates a procedure in which the RFID reader 100 one-to-one accesses one RFID tag 200 and may be known by those skilled in the art to which the present invention pertains. Therefore, a detailed description of the single tag authentication procedure will be omitted. In addition, the multi-tag authentication procedure indicates a procedure in which the RFID reader 100 selects one of a plurality of RFID tags 200 and may be known by those skilled in the art to which the present invention pertains. Therefore, a detailed description of the multi-tag authentication procedure will be omitted.

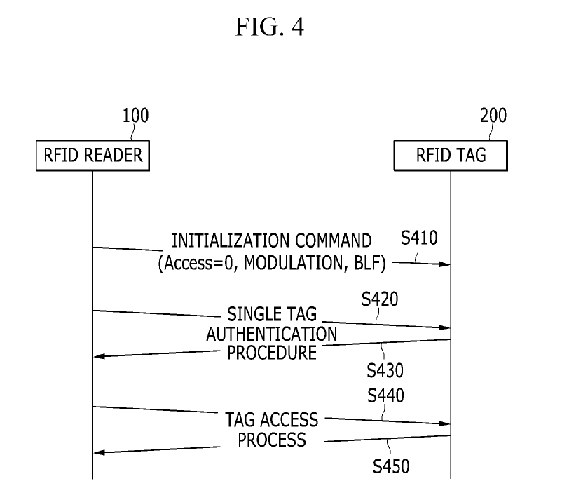

FIG. 4 is a diagram showing the case in which a single tag authentication procedure is performed through the initialization command according to an exemplary embodiment of the present invention. First, the RFID reader 100 transmits the initialization command to the

RFID tag 200 (S410). The RFID reader 100 configures the initialization command including the ACCESS field 320, the MODULATION field 330, and the BLF field 340 and transmits the configured initialization command to the RFID tag 200. Here, since the ACCESS field 320 of the initialization command is set to ‘0’, the single tag authentication procedure may be performed.

The RFID tag 200 receiving the initialization command may recognize that the single tag authentication procedure is performed through the ACCESS field 320 of the initialization command. In addition, the RFID tag 200 sets a transmission format, a data transmission speed, or the like, included in the initialization command and waits.

Then, the RFID reader 100 and the RFID tag 200 perform the single tag authentication procedure depending on the ACCESS field 320 (S420 and S430). The single tag authentication procedure is a procedure in which the RFID reader 100 one-to-one accesses one RFID tag 200.

After the single tag authentication procedure is performed, the RFID reader 100 and the RFID tag 200 perform a TAG ACCESS PROCESS (S440 and S450). In the TAG ACESS PROCESS, a data exchange, a state exchange, or the like, is performed between the RFID reader 100 and the RFID tag 200. That is, the RFID tag 200 may be in the ACESS STATE and may execute the tag data access command transmitted by the RFID reader 100.

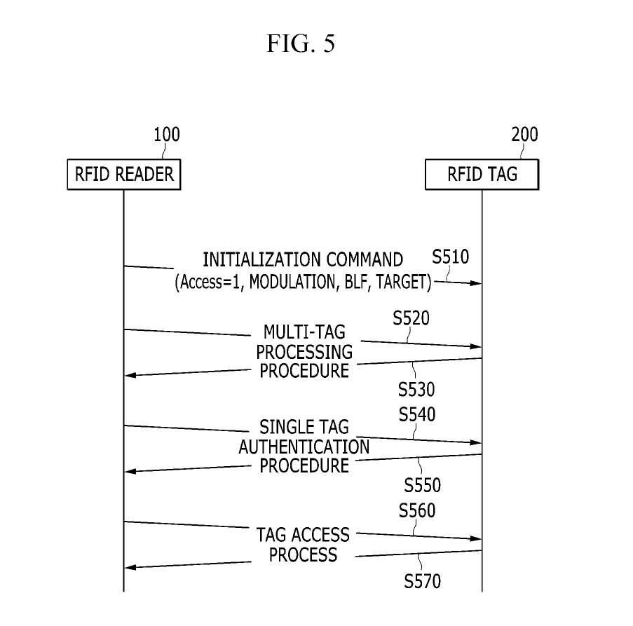

FIG. 5 is a diagram showing the case in which a multi-tag processing procedure is performed through the initialization command according to another exemplary embodiment of the present invention.

As shown in FIG. 5, the RFID reader 100 transmits the initialization command to the RFID tag 200 (S510). The RFID reader 100 configures the initialization command including the ACCESS field 320, the MODULATION field 330, and the BLF field 340 and transmits the configured initialization command to the RFID tag 200. Here, since the ACCESS field 320 of the initialization command is set to ‘1’, the multi-tag processing procedure may be performed. In addition, the initialization command may further include a TARGET field in which target tag information is indicated in order to process the multi-tag processing procedure of processing a plurality of RFID tags.

The RFID tag 200 receiving the initialization command may recognize that the multi-tag processing procedure is performed through the ACCESS field 320 of the initialization command. In addition, the RFID tag 200 sets a transmission format, a data transmission speed, or the like, included in the initialization command and waits.

Then, the RFID reader 100 and the RFID tag 200 perform the multi-tag processing procedure depending on the ACCESS field 320 (S520 and S530). The multi-tag processing procedure indicates a procedure in which the RFID reader 100 selects one of the plurality of RFID tags 200.

After the multi-tag processing procedure is performed, the RFID reader 100 and the RFID tag 200 perform the single tag authentication procedure (S540 and S550). The single tag authentication procedure is a procedure in which the RFID reader 100 one-to-one accesses one RFID tag 200.

After the single tag authentication procedure is performed, the RFID reader 100 and the RFID tag 200 perform a TAG ACCESS PROCESS (S560 and S570). In the TAG ACESS PROCESS, a data exchange, a state exchange, or the like, is performed between the RFID reader 100 and the RFID tag 200. That is, the RFID tag 200 may be in the ACESS STATE and may execute the tag data access command transmitted by the RFID reader 100.

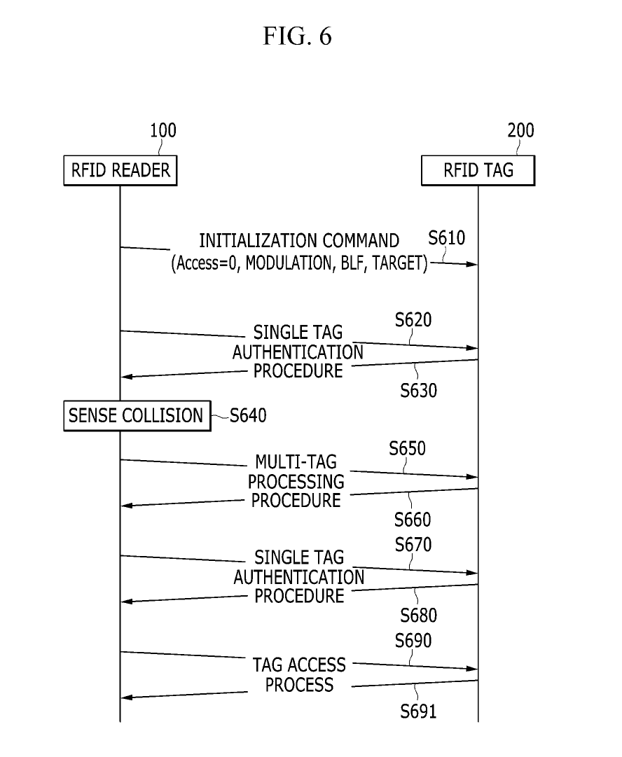

FIG. 6 is a diagram showing the case in which a single tag authentication procedure and a multi-tag processing procedure are performed through the initialization command according to still another exemplary embodiment of the present invention. That is, FIG. 6 shows the case in which the RFID tag 200 entering the single tag authentication procedure through the initialization command enters the multi-tag processing procedure due to sensing of the collision by the RFID reader 100.

First, the RFID reader 100 transmits the initialization command to the RFID tag 200 (S610). The RFID reader 100 configures the initialization command including the ACCESS field 320, the MODULATION field 330, and the BLF field 340 and transmits the configured initialization command to the RFID tag 200. Here, since the ACCESS field 320 of the initialization command is set to ‘0’, the single tag authentication procedure may be performed.

The RFID tag 200 receiving the initialization command may recognize that the single tag authentication procedure is performed through the ACCESS field 320 of the initialization command. In addition, the RFID tag 200 sets a transmission format, a data transmission speed, or the like, included in the initialization command and waits.

The RFID reader 100 and the RFID tag 200 perform the single tag authentication procedure depending on the ACCESS field 320 (S620 and S630). The single tag authentication procedure is a procedure in which the RFID reader 100 one-to-one accesses one RFID tag 200.

The RFID reader 100 determines whether a response of the RFID tag 200 in the single tag authentication procedure is received from the plurality of RFID tags 200, thereby sensing the collision (S640). That is, the RFID reader 100 senses the collision in the case in which the response is received from the plurality of RFID tags.

In the case in which the RFID reader 100 senses the collision, it commands the RFID tag to enter the multi-tag processing procedure, and the RFID reader 100 and the RFID tag 200 perform the multi-tag processing procedure (S650 and S660). The multi-tag processing procedure indicates a procedure in which the RFID reader 100 selects one of the plurality of RFID tags 200.

After the multi-tag processing procedure is performed, the RFID reader 100 and the RFID tag 200 perform the single tag authentication procedure (S670 and S680). The single tag authentication procedure is a procedure in which the RFID reader 100 one-to-one accesses one RFID tag 200.

After the single tag authentication procedure is performed, the RFID reader 100 and the RFID tag 200 perform a TAG ACCESS PROCESS (S690 and S691). In the TAG ACESS PROCESS, a data exchange, a state exchange, or the like, is performed between the RFID reader 100 and the RFID tag 200. That is, the RFID tag 200 may be in the ACESS STATE and may execute the tag data access command transmitted by the RFID reader 100.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An operating method of a radio frequency identification (RFID) reader accessing data of an RFID tag, comprising:
configuring an initialization command including a first field selecting a single tag accessing mode and a multi-tag processing mode;
transmitting the initialization command to the RFID tag; and
performing a single tag authentication procedure, which is a procedure of one-to-one accessing one RFID tag, in the case in which the first field is set to the single tag accessing mode.

2. The operating method of an RFID reader of claim 1, further comprising:
performing a multi-tag processing procedure, which is a procedure of selecting one of a plurality of RFID tags, in the case in which the first field is set to the multi-tag processing mode.

3. The operating method of an RFID reader of claim 1, further comprising:
after the performing of the single tag authentication procedure, determining whether a response has been received from a plurality of RFID tags; and
performing a multi-tag processing procedure, which is a procedure of selecting one of the plurality of RFID tags, in the case in which the response is received from the plurality of RFID tags.

4. The operating method of an RFID reader of claim 2, further comprising:
after the performing of the multi-tag processing procedure, performing the single tag authentication procedure.

5. The operating method of an RFID reader of claim 1, wherein:
the initialization command further includes a field indicating modulation and demodulation formats and a field indicating a data transmission speed.

6. The operating method of an RFID reader of claim 1, further comprising:
after the performing of the single tag authentication procedure, accessing the data of the RFID tag.

7. An operating method of an RFID tag transmitting data in the case in which the RFID tag is positioned in a recognition region of an RFID reader, comprising:
receiving an initialization command including a first field indicating a high speed operation mode and a general operation mode from the RFID reader; and
performing a single tag authentication procedure, which is a procedure of one-to-one accessing the RFID reader, in the case in which the first field is set to the high speed operation mode.

8. The operating method of an RFID tag of claim 7, further comprising:
performing a multi-tag processing procedure with the RFID reader, in the case in which the first field is set to the general operation mode.

9. The operating method of an RFID tag of claim 8, wherein:
the multi-tag processing procedure is a procedure in which the RFID reader selects one of the RFID tag and RFID tags other than the RFID tag.

10. The operating method of an RFID tag of claim 7, further comprising:
after the performing of the single tag authentication procedure, performing a multi-tag processing procedure with the RFID reader in the case in which the RFID reader receives a response from the RFID tag and RFID tags other than the RFID tag.

11. The operating method of an RFID tag of claim 7, wherein:
the initialization command further includes a field indicating modulation and demodulation formats and a field indicating a data transmission speed.

12. An RFID system comprising:
an RFID tag; and
an RFID reader accessing data of the RFID tag and transmitting an initialization command to the RFID tag,
wherein the initialization command includes a first field selecting a single tag accessing mode and a multi-tag processing mode, and the RFID reader performs a single tag authentication procedure, which is a procedure of one-to-one accessing one RFID tag, in the case in which the first field is set to the single tag accessing mode.

13. The RFID system of claim 12, wherein:
the RFID reader performs a multi-tag processing procedure, which is a procedure of selecting one of a plurality of RFID tags, in the case in which the first field is set to the multi-tag processing mode.

14. The RFID system of claim 12, wherein:
after the single tag authentication procedure is performed, the RFID reader performs a multi-tag processing procedure, which is a procedure of selecting one of a plurality of RFID tags in the case in which a response is received from the plurality of RFID tags.

15. The RFID system of claim 12, wherein:
the RFID reader includes a central processing unit configuring the initialization command, and
the central processing unit includes a tag mode selecting unit processing a command selecting one of the single tag accessing mode and the multi-tag processing mode.
